(19) United States
(12) Patent Application Publication
(10) Pub. No.: US 2019/0323212 A1
(43) Pub. Date: Oct. 24, 2019

(54) Rooftop Water Collection System

(71) Applicant: Merrill J. Stokes, Boerne, TX (US)

(72) Inventor: Merrill J. Stokes, Boerne, TX (US)

(21) Appl. No.: 15/959,236

(22) Filed: Apr. 22, 2018

(51) Int. Cl. E03B 3/03; C02F 1/00; C02F 1/32; C02F 1/28; C02F 1/38; C02F 1/467

(52) U.S. Cl. CPC E03B 3/03; C02F 1/001; C02F 1/4674; C02F 1/283; C02F 1/38; C02F 1/32

(57) ABSTRACT

A liquid purification system for collecting and bottling water may include a roof collector positioned a rooftop of a building; a purification device connected to the roof collector to purify the water; and a bottling device to clean containers and to store the water in the containers.

### FIELD OF THE INVENTION

The present invention relates to a water collection system and more particularly to a rooftop water collection system.

### BACKGROUND

The need for a source of water to be used and distributed as bottled water remains extremely strong. However, the current sources of water fail to recognize that a pure and wholesome source of water falls from the sky during rain storms. There needs to be a commercial system to collect this water and to bottle it to be distributed and sold in the marketplace.

### SUMMARY

A liquid purification system for collecting and bottling water may include a roof collector positioned a rooftop of a building; a purification device connected to the roof collector to purify the water; and a bottling device to clean containers and to store the water in the containers.

The purification device may include a sand trap device to separate sand and other debris from the water.

The purification device may include a centrifugal separator device which through centrifugal forces separates debris from the water.

The purification device may include a chlorinator tank to add chlorine to the water.

The purification device may include a granular activated carbon (GAC) tank to filter the water is filtered thru a granular activated carbon.
The purification device may include a sterilizer device to sterilize the water with ultraviolet light.
The purification device may include a scale inhibitor tank to add a scale inhibitor to the water.
The purification device may include a calcium chloride solution tank to add calcium chloride to the water.
The purification device may include a sodium carbonate solution tank to add sodium carbonate to the water.

The purification device may include a guardian ozone generator to generate ozone to treat the water.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a diagram of the present invention;

FIGS. 2a-b illustrates the steps of the present invention.

### DETAILED DESCRIPTION

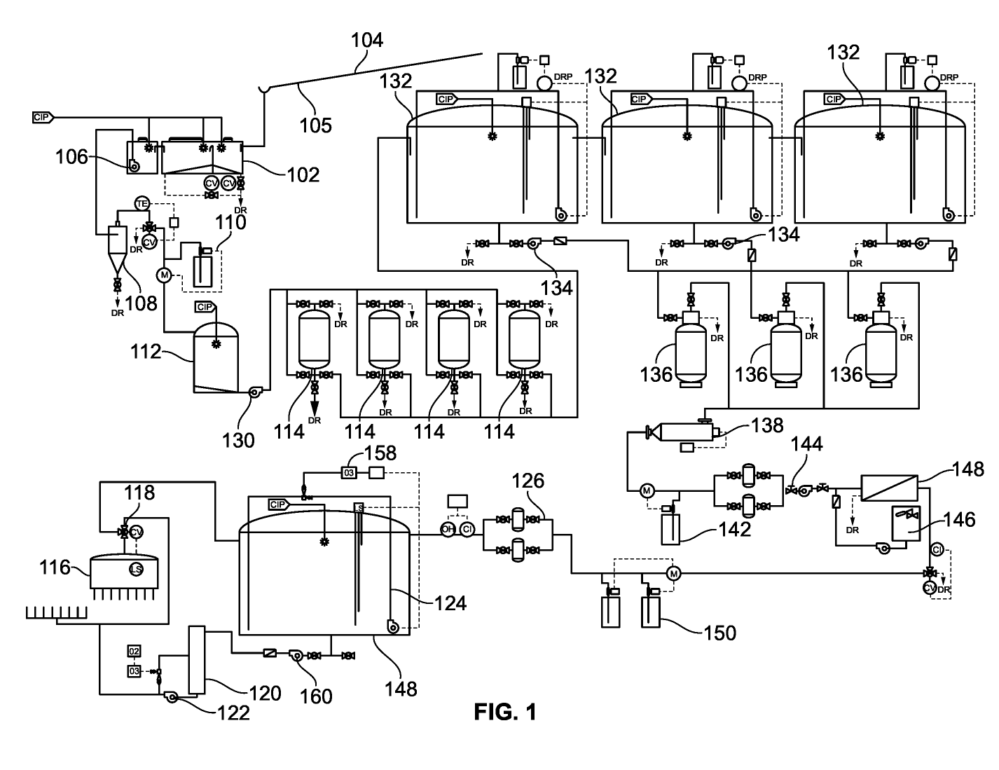

FIG. 1 illustrates the rooftop water collection system of the present invention and illustrates a roof collector 104 which may be positioned on a support surface such as a rooftop 105. The roof collector 104 may direct the water to a central location where the roof collector 104 is connected to a sand trap device 102 to separate sand and other debris from the water. The sand trap device 102 is connected to and transfers water to a clear well Jensen device 128. Pump device 106 pumps the water to the centrifugal separator device 108 which through centrifugal forces further separates further debris from the water. The chlorinator pump 110 adds chlorine to the water. The chlorine is obtained from the chlorine contact tank 112. The pump 130 pumps the water through the sand filter tank 114 which filters the sand from the water. The water is transferred to a storage tank 132 which may be one of a multitude of storage tanks 132. The pump 130 transfers the water to a granular activated carbon (GAC) tank 136 where the water is filtered thru the granular activated carbon. The water is transferred from the GAC tank 136 to the sterilizer device 138 where the water is sterilized by ultraviolet light. The scale inhibitor tank 142 adds a scale inhibitor to the water as the water is being pumped by pump 144 to the flush tank 146. From the flush tank, 146, the water is transferred to the permeate flush. There are several different membrane cleaning methods, such as forward flush, backward flush and air flush.
When forward flush is applied, membranes are flushed with feed water or permeate forward. The feed water or permeate flows through the system more rapidly than during the production phase. Because of the more rapid flow and the resulting turbulence, particles that are absorbed to the membrane are released and discharged.

As the water is being transferred to the storage tank 148, the calcium chloride solution tank 150 adds calcium chloride to the water. Next, the sodium carbonate solution tank 152 adds sodium carbonate to the water.

After the sodium carbonate has been added to the water, the water flows to the micron absolute elements device 126 (The absolute rating, of cut-off point, of a filter refers to the diameter of the largest spherical glass particle, normally expressed in micrometers (mm),), from the micron absolute elements device 126 the water is transmitted into the storage tank 148 where the water is treated by a guardian ozone generator to generate ozone to treat the water. From the storage tank 148, the water flows to pump 160 to the ozone system 120 and then to the mono block filler 118 which fills bottles with the treated water. The bottles have been rinsed by the bottle rinser 162.

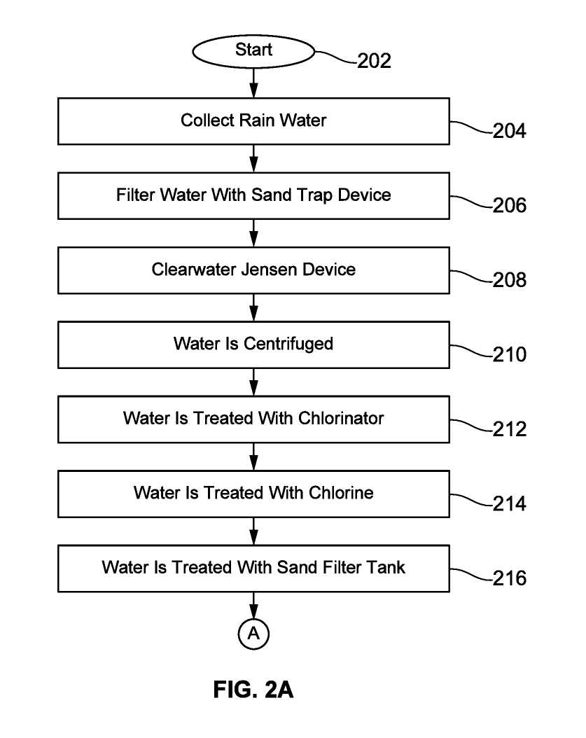

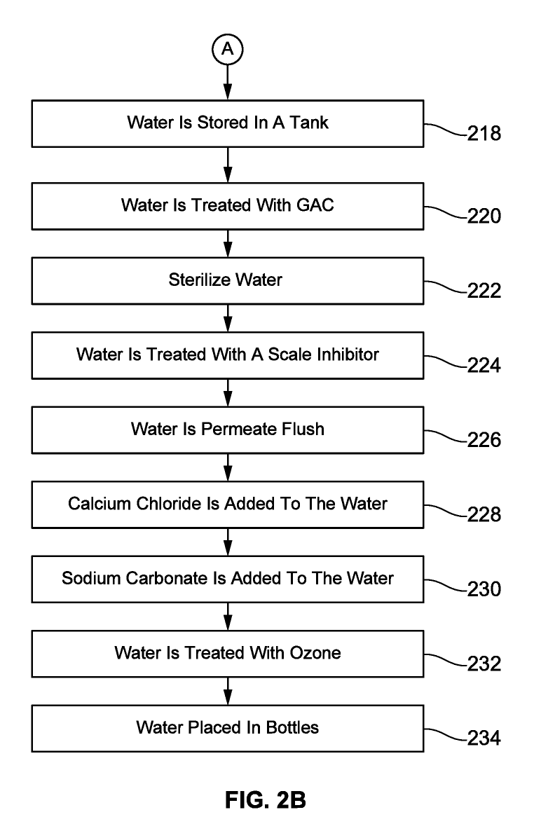

FIGS. 2a-b illustrates the steps of the collection and treatment process of the present invention. A specific order is shown in the figures; variations in the order of steps are within the scope of the present invention. The process begins in step 202, and in step 204, water in the form of rain is collected from the rooftop or other support surface. In step 208, the water is treated with a clearwater Jensen device, and in step 210, the water is centrifuged. In step 212, the water is treated with a chlorinator, and in step 214, the water is treated with chlorine. In step 216, the water is treated with a sand filter tank, and in step 218, the water is stored in a storage tank. The water is treated with GAC in step 220, and the water is sterilized in step 222. The water is treated with a scale inhibitor in step 224, and the water is treated with a permeate flush in step 226. In step 228, calcium chloride is added to the water, and in step 230, sodium carbonate is added to the water. In step 232 the water is treated with ozone, and the water is placed in bottles in step 234.

The above process and devices may be used on other fluids, water being a example.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A liquid purification system for collecting and bottling water, comprising:
a roof collector positioned a rooftop of a building;
a purification device connected to the roof collector to purify the water;
a bottling device to clean containers and to store the water in the containers.

2) A liquid purification system for collecting and bottling water as in claim 1, wherein the purification device includes a sand trap device to separate sand and other debris from the water.

3) A liquid purification system for collecting and bottling water as in claim 1, wherein the purification device includes a centrifugal separator device which through centrifugal forces separates debris from the water.

4) A liquid purification system for collecting and bottling water as in claim 1, wherein the purification device includes a chlorinator tank to add chlorine to the water.

5) A liquid purification system for collecting and bottling water as in claim 1, wherein the purification device includes a granular activated carbon (GAC) tank to filter the water is filtered thru a granular activated carbon.

6) A liquid purification system for collecting and bottling water as in claim 1, wherein the purification device includes a sterilizer device to sterilize the water with ultraviolet light.

7) A liquid purification system for collecting and bottling water as in claim 1, wherein the purification device includes a scale inhibitor tank to add a scale inhibitor to the water.

8) A liquid purification system for collecting and bottling water as in claim 1, wherein the purification device includes a calcium chloride solution tank to add calcium chloride to the water.

9) A liquid purification system for collecting and bottling water as in claim 1, wherein the purification device includes a sodium carbonate solution tank to add sodium carbonate to the water.

10) A liquid purification system for collecting and bottling water as in claim 1, wherein the purification device includes a guardian ozone generator to generate ozone to treat the water.
